(19) United States
(12) Patent Application Publication
(10) Pub. No.: US 2024/0361586 A1
(43) Pub. Date: Oct. 31, 2024

(54) BINOCULAR TELESCOPE

(71) Applicant: SHENZHEN RUIERXING ELECTRONIC CO., LTD., Shenzhen (CN)

(72) Inventors: Luxin Fu, Shenzhen (CN); Zhicheng Xing, Shenzhen (CN)

(21) Appl. No.: 18/220,247

(22) Filed: Jul. 10, 2023

(30) Foreign Application Priority Data
Apr. 28, 2023 (CN) 202310482917.9

(51) Int. Cl. G02B 23/18; G02B 3/00; G02B 7/00; G02B 23/02; G02B 27/09; G02B 27/14; G02F 1/13

(52) U.S. Cl. CPC G02B 23/18; G02B 3/0062; G02B 7/003; G02B 23/02; G02B 27/0916; G02B 27/141; G02F 1/1306

(57) ABSTRACT

A binocular telescope comprises a main housing, a first lens body and a second lens body which are rotatably mounted in the main housing, and a laser ranging component accommodated in the main housing, the laser ranging component comprising a base mounted in the main housing, a laser transmitting module and a laser receiving module which are mounted in the base, the laser ranging component being provided in front of the first lens body and the second lens body, so that a laser light path for range finding is separated from an observing light path of the first lens body and the second lens body, and the laser light path is independently provided in front of the observing light path.

### CROSS-REFERENCE TO RELATED APPLICATIONS

The present application claims priority of Chinese Patent Application No. 202310482917.9, filed on Apr. 28, 2023, the entire contents of which are hereby incorporated by reference.

### TECHNICAL FIELD

The present invention relates to the field of photoelectric technology, and particularly to a binocular telescope.

### DESCRIPTION OF THE PRIOR ART

In a typical binocular telescope, a laser transmitting path and a laser receiving path for laser distance measuring are mixed in a prism group. The laser transmitting path and laser receiving path pass through too many surfaces via the prism group, resulting in a significant decrease in laser power. When an object at long-distance is measured, it is necessary to increase laser power. However, the increased laser power increases a risk of laser path leakage to the eyepiece group due to the laser transmitting path mixed in the prism group; moreover, adjustments of the typical binocular telescope are too complicated due to the mixing of the laser path and observation light path.

### SUMMARY OF THE DISCLOSURE

In view of the above, the present invention provides a binocular telescope capable of solving or optimizing the above problems.

The binocular telescope, comprising: a main housing, a first lens body and a second lens body which are rotatably mounted in the main housing, and a laser ranging component accommodated in the main housing, the laser ranging component comprising a base mounted in the main housing, a laser transmitting module and a laser receiving module which are mounted in the base, the laser ranging component being provided in front of the first lens body and the second lens body, so that a laser light path for range finding is separated from an observing light path of the first lens body and the second lens body, and the laser light path is independently provided in front of the observing light path.

In some embodiments, the laser transmitting module comprises a laser emitter for transmitting laser beams, a first laser mirror for reflecting the transmitted laser beams, a laser transmitting lens for converging the reflected laser beams, and a first dichroic mirror for reflecting laser light and allowing natural light to pass therethrough.

In some embodiments, the laser receiving module comprises a second dichroic mirror for reflecting the laser beams turned back from the target and allowing natural light to pass therethrough, a laser receiving lens for converging the reflected laser beams, a second laser mirror for reflecting the converged laser beams, and a laser receiver for receiving the laser beams reflected by the second laser mirror.

In some embodiments, a construction of the first lens body is the same as a construction of the second lens body, the first lens body comprises a first lens tube, a mounting base installed inside the first lens tube, a first objective lens group and a first eyepiece group which are movably installed in the mounting base, and a first prism group, a first natural light mirror, and a third dichroic mirror which are fixed in the mounting base, a data display screen is mounted on a specific focal point of the first eyepiece group of the first lens body, so that a ranging center and a ranging data can be displayed in user's eyes together with an observation image.

In some embodiments, the first dichroic mirror, the first objective lens, the first prism group, and the first natural light mirror are arranged on a first axis; the data display screen, the third dichroic mirror, and the first eyepiece group are arranged on a second axis, and the first axis is parallel to the second axis.

In some embodiments, the first natural light mirror and the third dichroic mirror are opposite each other.

In some embodiments, a movement of the first objective lens group is carried out through a focal length adjusting component mounted on a rear housing of the main housing.

In some embodiments, the focal length adjusting component comprises a guiding rod mounted in the rear housing, a movable element movably mounted on the guiding rod, and a knob capable of driving the movable element to move.

In some embodiments, the knob is connected to the movable element through a connecting rod.

In some embodiments, an end of the movable element away from the knob is provided with a groove facing the first objective lens group.

In some embodiments, a first lens body mounting portion of the rear housing is provided with a first opening at a position corresponding to the groove, and the mounting base is provided with a second opening at a position corresponding to the groove, and a convex column arranged on the first objective lens base passes through the second opening and the first opening and is engaged in the groove.

In some embodiments, the laser transmitting module comprises a laser emitter for transmitting laser beams, a laser transmitting lens for converging the reflected laser beams, and a first dichroic mirror for reflecting natural light and allowing laser light to pass therethrough.

In some embodiments, the laser receiving module comprises a second dichroic mirror for allowing the laser beams turned back from the target to pass therethrough and reflecting natural light, a laser receiving lens for converging the transmitted laser beams, and a laser receiver for receiving the converged laser beams.

In some embodiments, a construction of the first lens body is the same as a construction of the second lens body, the first lens body comprises a first lens tube, a mounting base installed inside the first lens tube, a first objective lens group and a first eyepiece group which are movably installed in the mounting base, and a first prism group, a first natural light mirror, and a fourth natural light mirror which are fixed in the mounting base, a transparent LCD screen is mounted on a specific focal point of the first eyepiece group of the first lens body, so that a ranging center and a ranging data can be displayed in user's eyes together with an observation image.

In some embodiments, the second natural light mirror, the first objective lens, the first prism group, and the first natural light mirror are arranged on a first axis, the fourth natural light mirror, the transparent LCD screen and the first eyepiece group are arranged on a second axis, and the first axis is parallel to the second axis.

In some embodiments, a movement of the first objective lens group is carried out through a focal length adjusting component mounted on a rear housing of the main housing, and the focal length adjusting component comprises a guiding rod mounted in the rear housing, a movable element movably mounted on the guiding rod, and a knob capable of driving the movable element to move.

In some embodiments, the knob is connected to the movable element through a connecting rod.

In some embodiments, an end of the movable element away from the knob is provided with a groove facing the first objective lens group.

In some embodiments, a first lens body mounting portion of the rear housing is provided with a first opening at a position corresponding to the groove, and the mounting base is provided with a second opening at a position corresponding to the groove, and a convex column arranged on the first objective lens base passes through the second opening and the first opening and is engaged in the groove.

In some embodiments, the first lens body is configured with a data display screen, and the second lens body is configured with a transparent LCD screen.

Compared with the prior art, the advantageous effects of the present invention are that:
1. In the present invention, the laser path for ranging is separated before the visual observing light path so that the laser transmitting and receiving paths are independently set at a front end of the visual observing light path, and after the laser light path and the observing light path are separated, the total laser power of the laser light path is higher under the same laser transmitting power.
2. In the present invention, the number of reflect surfaces through which the laser transmitting and receiving paths are separated is reduce, the laser power is improved, and the risk of leakage of the laser light paths to the observing light paths is reduced after the laser light paths are separated.
3. After the laser light path and the observing light path are independent, the adjustment of the laser light path and the observing light path are divided into two independent systems, and the two systems can move independently to reduce the adjustment difficulty so that adjustment in a production link is greatly simplified.

### BRIEF DESCRIPTION OF DRAWINGS

FIG. 1 shows a perspective view of a binocular telescope according to an embodiment of the present invention.

FIG. 2 shows a perspective view of the other direction of the binocular telescope shown in FIG. 1.

FIG. 3 shows an exploded view of the binocular telescope shown in FIG. 1, which further shows a partially enlarged view.

FIG. 4 shows a perspective view of a laser ranging component and an observing component of a first embodiment of the binocular telescope shown in FIG. 1.

FIG. 5 shows a plan view of a laser ranging mechanism in FIG. 4.

FIG. 6 shows a plan view of the observing mechanism in FIG. 4.

FIG. 7 shows a cross-sectional view along line A-A of the laser ranging component shown in FIG. 5 and along line B-B of the observing component shown in FIG. 6, which further schematically shows a laser light path and a the visual observing light path to clearly show the light path of laser and natural light in the binocular telescope.

FIG. 8 shows a cross-sectional view of the laser ranging component and the observing component of a second embodiment of the binocular telescope shown in FIG. 1, which further schematically shows a laser light path and a the visual observing light path to clearly show the light path of laser and natural light in the binocular telescope.

Reference numerals: 1—binocular telescope; 11—main housing; 111—front housing; 112—rear housing; 121—first lens body mounting portion; 122—second lens body mounting portion; 123—first opening; 124—connecting plate; 125—recess; 12—first lens body; 13—second lens body; 14—focal length adjusting component; 141—knob; 142—connecting rod; 143—movable element; 431—guiding rod; 432—groove; 20—base; 21—laser transmitting module; 211—laser emitter; 212—first laser mirror; 213—laser transmitting lens; 214—first dichroic mirror; 215—second natural light mirror; 210—laser transmitting path; 22—laser receiving module; 221—laser receiver; 222—second dichroic mirror; 223—laser receiving lens; 224—second laser mirror; 225—third natural light mirror; 220—laser receiving path; 30—first lens tube; 301—mounting base; 310—second opening; 31—first objective lens group; 311—first objective lens base; 312—first objective lens; 313—convex column; 32—first prism group; 33—first natural light mirror; 341—data display screen; 342—transparent LCD screen; 35—data display coupling lens; 36—third dichroic mirror; 37—first eyepiece group; 38—visibility adjusting ring; 39—fourth natural light mirror; 300—visual observing light path; A—first axis; B—second axis.

### DESCRIPTION OF EMBODIMENTS

In order to facilitate understanding of the present invention, the present invention will now be described more fully with reference to the drawings. One or more embodiments of the present invention are shown by way of example in the drawings, in order to provide a more accurate and thorough understanding of the disclosed technical solution. However, it should be understood that the present invention may be realized in many different forms and is not limited to the embodiments described below.

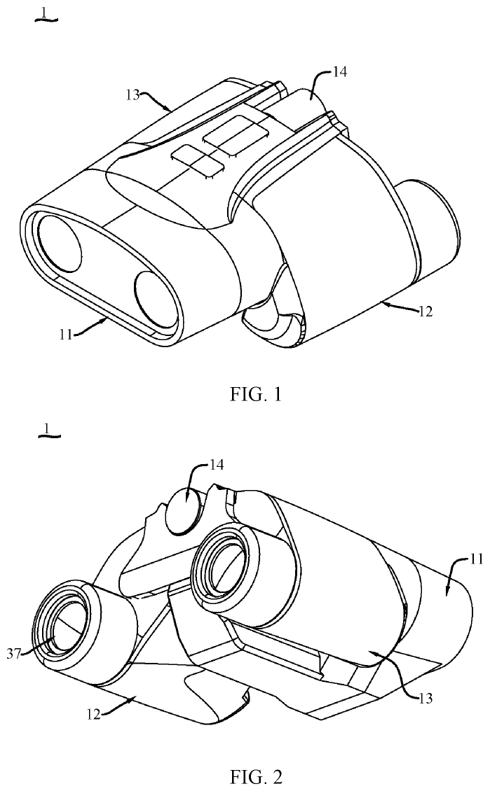

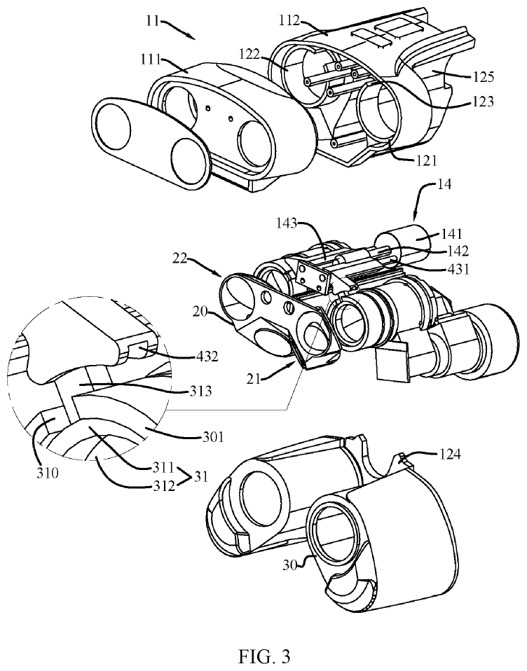

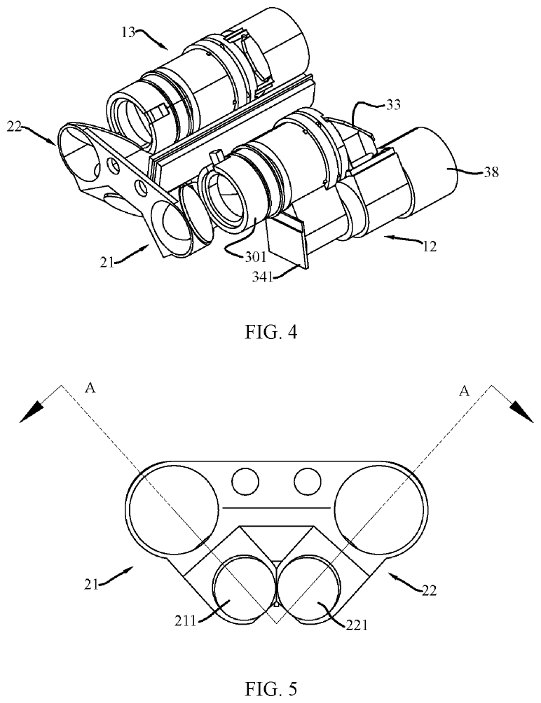

Referring to FIGS. 1 to 3, a binocular telescope 1 according to an embodiment of the present invention includes a main housing 11, a first lens body 12 and a second lens body 13 which are rotatably mounted in the main housing 11, and a laser ranging component accommodated in the main housing 11. The laser ranging component includes a base 20 mounted in the main housing 11, a laser transmitting module 21 and a laser receiving module 22 which are mounted in the base 20. In the description of orientation herein, a direction adjacent/toward the target is defined as forward and a direction away from the target is defined as rearward. In the embodiment, the main housing 11 includes a front housing 111 and a rear housing 112 mounted a rear side of the front housing 111, wherein the laser transmitting module 21 and the laser receiving module 22 are mounted in an accommodation space formed by the front housing 111 and the rear housing 112. The first lens body 12 and the second lens body 13 are rotatably mounted in the rear housing 112 respectively. Preferably, the rear housing 112 is provided with a first lens body installation portion 121 and a second lens body installation portion 122, and a connecting plate 124 is mounted at an end of the rear housing 112 away from the front housing 111. The first lens body 12 is rotatably mounted between the first lens body installation portion 121 and the connecting plate 124. The second lens body 13 is rotatably mounted between the second lens body mounting portion 122 and the connecting plate 124. In this embodiment, the first lens body installation portion 121 and the second lens body installation portion 122 are symmetrically arranged relative to a central axis of the rear housing 112. A part of the rear housing 112 adjacent to the first lens body 12 or the second lens body 13 is provided with a recess 125, which is connected with a convex portion of the first lens body 12 or the second lens body 13, and does not hinder a rotation of the first lens body 12 in the first lens body mounting portion 121 or the second lens body 13 in the second lens body mounting portion 122 around the rear housing 112, so that the binocular telescope 1 is capable of meeting different pupil distances. The laser transmitting module 21 is configured to emit desired laser beams and transmit the laser beams to a target. The laser receiving module 22 is configured to receive the laser beams reflected from the target. The laser transmitting module 21 and the laser receiving module 22 are fixedly mounted in the front housing 111 through the base 20.

### Embodiment 1

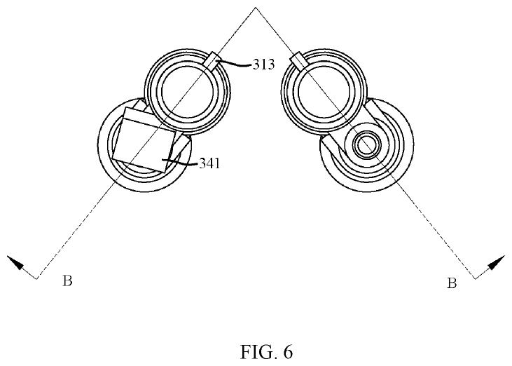

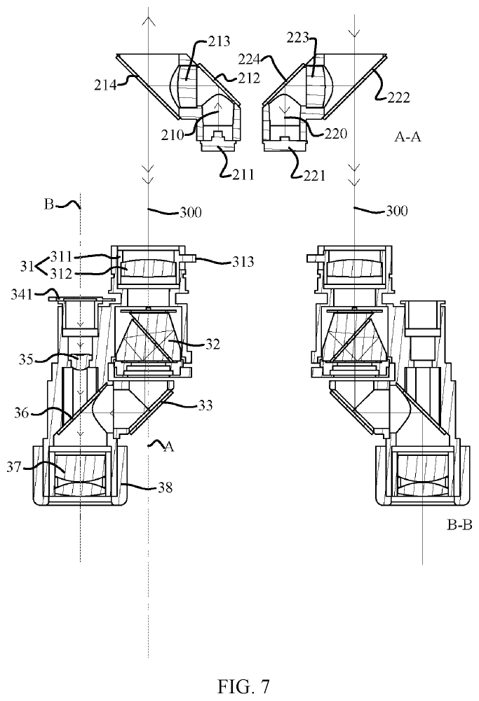

FIGS. 1 to 7 show a first embodiment of the binocular telescope 1 of the present invention.

In this embodiment, the laser transmitting module 21 includes a laser emitter 211 for transmitting laser beams, a first laser mirror 212 for reflecting the transmitted laser beams, a laser transmitting lens 213 for converging the reflected laser beams, and a first dichroic mirror 214 for reflecting laser light and allowing natural light to pass therethrough. The laser emitter 211 transmits laser light to the first laser mirror 212, and then the laser light is turned and projected onto the laser transmitting lens 213, and the laser transmitting lens converges the laser light and projects it onto the first dichroic mirror 214, and finally, the laser light is reflected onto a target through the first dichroic mirror 214, and thus the laser emission path 210 is formed. Preferably, the laser transmitting lens 213 is a laser transmitting optical lens. The first dichroic mirror 214 adopts narrow-band coating film, which can reflect a specific wavelength of laser towards the target and allow light in a natural light band to pass through. Preferably, the first laser mirror 212 is located in front of the laser emitter 21, and the first laser mirror 212 is opposite to the first dichroic mirror 214, and the laser transmitting lens 213 is located between the first laser mirror 212 and the first dichroic mirror 214. In this embodiment, the first laser mirror 212 is capable of totally reflecting the laser beams. Laser light is emitted by the laser emitter 211, is deflected by the first laser mirror 212 and converged by the laser transmitting lens 213 to reach the first dichroic mirror 214, and then reflected again and reaches the target.

The laser beams emitted by the laser transmitting path 210 towards the target is reflected after reaching the target, and the laser beams reflected back from the target is received by the laser receiving module 22. The laser receiving module 22 includes a second dichroic mirror 222 for reflecting the laser beams turned back from the target and allowing natural light to pass therethrough, a laser receiving lens 223 for converging the reflected laser beams, a second laser mirror 224 for reflecting the converged laser beams, and a laser receiver 221 for receiving the laser beams reflected by the second laser mirror 224. The laser beam returned from the target is reflected by the second dichroic mirror 222, then converged and projected onto the second laser mirror 224 through the laser receiving lens 223, and then deflected to the laser receiver 221 through the second laser mirror 224, and thus a laser receiving path 220 is formed. Preferably, the laser receiving lens 223 is a laser receiving optical lens. The second dichroic mirror 222 adopts narrow-band coating film, which can reflect a specific wavelength of laser towards the laser receiving lens 223 and allow light in a natural light band to pass through. Preferably, the second laser mirror 224 is located in front of the laser receiver 22, and the second laser mirror 224 is opposite to the second dichroic mirror 222, with the laser receiving lens 223 located between the second laser mirror 224 and the second dichroic mirror 222. In this embodiment, the second laser mirror 224 is capable of totally reflecting the laser beams. The laser beams returned from the target is reflected by the second dichroic mirror 222, then converged by the laser receiving lens 223 and deflected by the second laser mirror 224, and then received by the laser receiver 221. In this embodiment, the laser receiver 221 converts a received optical signal into an electrical signal. The data (such as ranging center and ranging data) after distance measurement is displayed on a data display screen 341.

The data display screen 341 is mounted on specific focal points of a first eyepiece group 37 and a second eyepiece group, respectively, so that the ranging center and ranging data can be displayed in user's eyes together with an observation image. A first optical path of the natural light path in the first lens body 12 is used to illustrate a composition of a visual observing light path 300.

The first lens body 12 includes a first lens tube 30, a mounting base 301 installed inside the first lens tube 30, a first objective lens group 31 and a first eyepiece group 37 which are movably installed in the mounting base 301, and a first prism group 32, a first natural light mirror 33, and a third dichroic mirror 36 which are fixed in the mounting base 301. Natural light of the target image to be observed is converged through the first objective lens group 31, and then is turned through the first prism group 32, and is projected towards the first eyepiece group 37 after passing through the first natural light mirror 33 and the third dichroic mirror 36, and thus the visual observing light path 300 of the first optical path of the natural light path is formed. Preferably, a coating film of the third dichroic mirror 36 is capable of reflecting natural light and allowing a transmission of specific wavelengths of light generated by the data display screen 341. The first eyepiece group 31 restores the image and projects it onto the user's eye. The distance measured data is displayed on the data display screen 341, and the displayed data image is converged through a data display coupling lens 35 located on the back of the data display screen 341 and projected onto the first eyepiece group 37 through the third dichroic mirror 36. At this time, the natural light path and the light path displaying the data are mixed into a whole image, which is then restored through the first eyepiece group 31 and projected onto the user's eye. At this time, the user can see both the target image and the ranging data image. A center point of the first optical path of the natural light path, a center point of the laser transmitting path, and a center point of the data display optical path are coincided as a center point, and a center point displayed in the data display optical path as seen by an observer is the center point of the visual observing light path and also the center point of the ranging optical path. A center point of a second optical path of the natural light path also coincides with the center point of the laser receiving path. A visual observing light path of the second optical path of the natural light path is the same as the visual observing light path 300 of the first optical path of the natural light path, and will not be repeated here.

The first objective lens group 31 includes a first objective lens base 311 movably installed in the mounting base 301 and a first objective lens 312 fixed in the first objective lens base 311. A movement of the first objective lens group 31 relative to the mounting base 301 realizes an adjustment of the focal length of the binocular telescope. A movement of the first objective lens group 31 is carried out through a focal length adjusting component 14 mounted on the rear housing 112 of the main housing 11. The focal length adjusting component 14 includes a guiding rod 431 mounted in the rear housing 112, a movable element 143 movably mounted on the guiding rod 431, and a knob 141 capable of driving the movable element 143 to move. In this embodiment, the knob 141 is connected to the movable element 143 through a connecting rod 142. Specifically, the connecting rod 142 rotates with a rotation of the knob 141, and is connected to the movable element 143 through a threaded connection, so that the rotation of the knob 141 can drive a forward and backward movement of the movable element 143. An end of the movable element 143 away from the knob 141 is provided with a groove 432 facing the first objective lens group 31. A first lens body mounting portion 121 of the rear housing 112 is provided with a first opening 123 at a position corresponding to the groove 432, and the mounting base 301 is provided with a second opening 310 at a position corresponding to the groove 432. A convex column 313 arranged on the first objective lens base 311 passes through the second opening 310 and the first opening 123 and is engaged in the groove 432. With a cooperation of the groove 432 and the convex column 313, the rotation of the knob 141 drives the movable element 143 to move back and forth, which drives the first objective lens group 31 to move back and forth, so as to realize the focus adjustment of the binocular telescope.

Preferably, the first dichroic mirror 214, the first objective lens 312, the first prism group 32, and the first natural light mirror 33 are arranged on a first axis A. The data display screen 341, the data display coupling lens 35, the third dichroic mirror 36, and the first eyepiece group 37 are arranged on a second axis B. The first axis A is parallel to the second axis B. In this embodiment, the first natural light mirror 33 and the third dichroic mirror 36 are opposite each other. In addition, as eyesight of user is not uniform, the eyepiece group can be adjusted by a visibility adjusting ring 38 to drive a visibility adjusting mechanism to move the focal length of the eyepiece group and the data display screen, so that the visibility can also be adjusted appropriately to the user's eyes.

### Embodiment 2

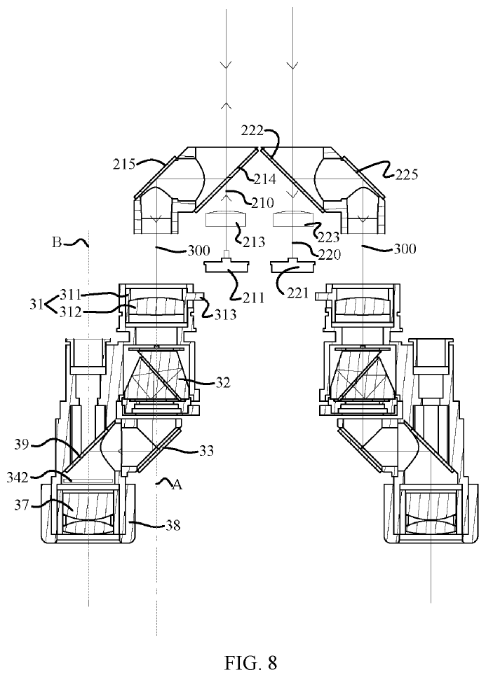

FIGS. 1, 2 and 8 show a second embodiment of the binocular telescope 1 of the present invention.

In this embodiment, the laser transmitting module 21 includes a laser emitter 211 for transmitting laser beams, a laser transmitting lens 213 for converging the reflected laser beams, and a first dichroic mirror 214 for reflecting natural light and allowing laser light to pass therethrough. The laser emitter 211 transmits laser light to the laser transmitting lens 213, and then the laser transmitting lens 213 converges the laser light and projects it onto the first dichroic mirror 214, and finally, the laser light is transmitted onto a target through the first dichroic mirror 214, and thus the laser emission path 210 is formed. Preferably, the laser transmitting lens 213 is a laser transmitting optical lens. The first dichroic mirror 214 is capable of transmitting a specific wavelength of laser towards the target and reflecting light in a natural light band. Laser light is emitted by the laser emitter 211, is converged by the laser transmitting lens 213 to reach the first dichroic mirror 214, and then is transmitted to the target.

The laser beams emitted by the laser transmitting path 210 towards the target is reflected after reaching the target, and the laser beams reflected back from the target is received by the laser receiving module 22. The laser receiving module 22 includes a second dichroic mirror 222 for allowing the laser beams turned back from the target to pass therethrough and reflecting natural light, a laser receiving lens 223 for converging the transmitted laser beams, and a laser receiver 221 for receiving the converged laser beams. The laser beams returned from the target is transmitted by the second dichroic mirror 222, then converged and projected onto the laser receiver 221 through the laser receiving lens 223, and thus a laser receiving path 220 is formed. Preferably, the laser receiving lens 223 is a laser receiving optical lens. The second dichroic mirror 222 is capable of allowing a specific wavelength of laser to pass through and reflecting light in a natural light band. The laser beams returned from the target is transmitted by the second dichroic mirror 222, and then converged by the laser receiving lens 223, and then received by the laser receiver 221. In this embodiment, the laser receiver 221 converts a received optical signal into an electrical signal. The data (such as ranging center and ranging data) after distance measurement is displayed on a transparent LCD screen 342.

The transparent LCD screen 342 is mounted on a specific focal points of a first eyepiece group 37 and a second eyepiece group, respectively, so that the ranging center and ranging data can be displayed in user's eyes together with an observation image. A first optical path of the natural light path in the first lens body 12 is used to illustrate a composition of a visual observing light path 300.

The first lens body 12 includes a first lens tube 30, a mounting base 301 installed inside the first lens tube 30, a first objective lens group 31 and a first eyepiece group 37 which are movably installed in the mounting base 301, and a first prism group 32, a first natural light mirror 33, and a fourth natural light mirror 39 which are fixed in the mounting base 301. Natural light of the target image to be observed is converged through the first objective lens group 31, and then is turned through the first prism group 32, and is projected towards the transparent LCD screen 342 after turned through the first natural light mirror 33 and the fourth natural light mirror 39, and then is projected towards the first eyepiece group 37, and thus the visual observing light path 300 of the first optical path of the natural light path is formed. The distance measured data is displayed on the transparent LCD screen 342, and is projected onto the first eyepiece group 37. At this time, the natural light path and the light path displaying the data are mixed into a whole image, which is then restored through the first eyepiece group 31 and projected onto the user's eye. At this time, the user can see both the target image and the ranging data image. A center point of the first optical path of the natural light path, a center point of the laser transmitting path, and a center point of the data display optical path are coincided as a center point, and a center point displayed in the data display optical path as seen by an observer is the center point of the visual observing light path and also the center point of the ranging optical path. A center point of a second optical path of the natural light path also coincides with the center point of the laser receiving path. A visual observing light path of the second optical path of the natural light path is the same as the visual observing light path 300 of the first optical path of the natural light path, and will not be repeated here. In addition, the adjusting mechanism and the structure of the first objective lens group 31 in this embodiment can adopt the adjusting mechanism and the structure in the first embodiment, and will not be repeated here.

Preferably, the second natural light mirror 215, the first objective lens 312, the first prism group 32, and the first natural light mirror 33 are arranged on a first axis A. The fourth natural light mirror 39, the transparent LCD screen 342 and the first eyepiece group 37 are arranged on a second axis B. The first axis A is parallel to the second axis B. In this embodiment, the first natural light mirror 33 and the fourth natural light mirror 39 are opposite each other. In addition, as an eyesight of user is not uniform, the eyepiece group can be adjusted by a visibility adjusting ring 38 to drive a visibility adjusting mechanism to move the focal length of the eyepiece group and the transparent LCD screen 342, so that the visibility can also be adjusted appropriately to the user's eyes.

### Embodiment 3

In this embodiment, the first lens body uses the data display screen 341 in the first embodiment, and the second lens body uses the transparent LCD screen 342 in the second embodiment, that is, the data display screen 341 and the transparent LCD screen 342 can be used in the same binocular telescope at the same time.

In the binocular telescope provided by the present invention, the laser optical path and the observing optical path are separated, the total laser power of the laser optical path is higher under the same laser tube emission power; and a risk of the laser light path leaking out to the observing light path is reduced, and adjustment in a production link is greatly simplified.

The above is only preferred embodiments of the present invention, and is not intended to limit the present invention. Any simple change or equivalent replacement of the technical solution that can be easily obtained by any person familiar with the technical field within the technical scope disclosed by the invention falls within the protection scope of the invention.

1. A binocular telescope, comprising: a main housing, a first lens body and a second lens body which are rotatably mounted in the main housing, and a laser ranging component accommodated in the main housing, the laser ranging component comprising a base mounted in the main housing, a laser transmitting module and a laser receiving module which are mounted in the base, the laser ranging component being provided in front of the first lens body and the second lens body, so that a laser light path for range finding is separated from an observing light path of the first lens body and the second lens body, and the laser light path is independently provided in front of the observing light path.

2. The binocular telescope according to claim 1, wherein the laser transmitting module comprises a laser emitter for transmitting laser beams, a first laser mirror for reflecting the transmitted laser beams, a laser transmitting lens for converging the reflected laser beams, and a first dichroic mirror for reflecting laser light and allowing natural light to pass therethrough.

3. The binocular telescope according to claim 2, wherein the laser receiving module comprises a second dichroic mirror for reflecting the laser beams turned back from the target and allowing natural light to pass therethrough, a laser receiving lens for converging the reflected laser beams, a second laser mirror for reflecting the converged laser beams, and a laser receiver for receiving the laser beams reflected by the second laser mirror.

4. The binocular telescope according to claim 2, wherein a construction of the first lens body is the same as a construction of the second lens body, the first lens body comprises a first lens tube, a mounting base installed inside the first lens tube, a first objective lens group and a first eyepiece group which are movably installed in the mounting base, and a first prism group, a first natural light mirror, and a third dichroic mirror which are fixed in the mounting base, a data display screen is mounted on a specific focal point of the first eyepiece group of the first lens body, so that a ranging center and a ranging data can be displayed in user's eyes together with an observation image.

5. The binocular telescope according to claim 4, wherein the first dichroic mirror, the first objective lens, the first prism group, and the first natural light mirror are arranged on a first axis; the data display screen, the third dichroic mirror, and the first eyepiece group are arranged on a second axis, and the first axis is parallel to the second axis.

6. The binocular telescope according to claim 4, wherein the first natural light mirror and the third dichroic mirror are opposite each other.

7. The binocular telescope according to claim 4, wherein a movement of the first objective lens group is carried out through a focal length adjusting component mounted on a rear housing of the main housing.

8. The binocular telescope according to claim 7, wherein the focal length adjusting component comprises a guiding rod mounted in the rear housing, a movable element movably mounted on the guiding rod, and a knob capable of driving the movable element to move.

9. The binocular telescope according to claim 8, wherein the knob is connected to the movable element through a connecting rod.

10. The binocular telescope according to claim 8, wherein an end of the movable element away from the knob is provided with a groove facing the first objective lens group.

11. The binocular telescope according to claim 10, wherein a first lens body mounting portion of the rear housing is provided with a first opening at a position corresponding to the groove, and the mounting base is provided with a second opening at a position corresponding to the groove, and a convex column arranged on the first objective lens base passes through the second opening and the first opening and is engaged in the groove.

12. The binocular telescope according to claim 1, wherein the laser transmitting module comprises a laser emitter for transmitting laser beams, a laser transmitting lens for converging the reflected laser beams, and a first dichroic mirror for reflecting natural light and allowing laser light to pass therethrough.

13. The binocular telescope according to claim 12, wherein the laser receiving module comprises a second dichroic mirror for allowing the laser beams turned back from the target to pass therethrough and reflecting natural light, a laser receiving lens for converging the transmitted laser beams, and a laser receiver for receiving the converged laser beams.

14. The binocular telescope according to claim 12, wherein a construction of the first lens body is the same as a construction of the second lens body, the first lens body comprises a first lens tube, a mounting base installed inside the first lens tube, a first objective lens group and a first eyepiece group which are movably installed in the mounting base, and a first prism group, a first natural light mirror, and a fourth natural light mirror which are fixed in the mounting base, a transparent LCD screen is mounted on a specific focal point of the first eyepiece group of the first lens body, so that a ranging center and a ranging data can be displayed in user's eyes together with an observation image.

15. The binocular telescope according to claim 14, wherein the second natural light mirror, the first objective lens, the first prism group, and the first natural light mirror are arranged on a first axis, the fourth natural light mirror, the transparent LCD screen and the first eyepiece group are arranged on a second axis, and the first axis is parallel to the second axis.

16. The binocular telescope according to claim 14, wherein a movement of the first objective lens group is carried out through a focal length adjusting component mounted on a rear housing of the main housing, and the focal length adjusting component comprises a guiding rod mounted in the rear housing, a movable element movably mounted on the guiding rod, and a knob capable of driving the movable element to move.

17. The binocular telescope according to claim 16, wherein the knob is connected to the movable element through a connecting rod.

18. The binocular telescope according to claim 17, wherein an end of the movable element away from the knob is provided with a groove facing the first objective lens group.

19. The binocular telescope according to claim 18, wherein a first lens body mounting portion of the rear housing is provided with a first opening at a position corresponding to the groove, and the mounting base is provided with a second opening at a position corresponding to the groove, and a convex column arranged on the first objective lens base passes through the second opening and the first opening and is engaged in the groove.

20. The binocular telescope according to claim 1, wherein the first lens body is configured with a data display screen, and the second lens body is configured with a transparent LCD screen.
